(19) United States
(12) Patent Application Publication
(10) Pub. No.: US 2021/0361140 A1
(43) Pub. Date: Nov. 25, 2021

(54) ENERGY RECOVERY FROM HOT WARES

(71) Applicant: ILLINOIS TOOL WORKS INC., Glenview, IL (US)

(72) Inventors: Alexander R. Anim-Mensah, Miamisburg, OH (US); Robert J. Zito, Dayton, OH (US); Don E. Iles, Troy, OH (US); Shane T. Kosir, Kirtland, OH (US); Prasanna V. Murlidharan, Columbus, OH (US)

(21) Appl. No.: 17/046,895

(22) PCT Filed: Apr. 18, 2019
(86) PCT No.: PCT/US2019/028083

§ 371 Date: Oct. 12, 2020

Related U.S. Application Data
(60) Provisional application No. 62/661,734, filed on Apr. 24, 2018.

(51) Int. Cl. A47L 15/42; A47L 15/24; A47L 15/00; A47L 15/48

(52) U.S. Cl. CPC A47L 15/4291; A47L 15/486; A47L 15/0047; A47L 15/241

(57) ABSTRACT

A device for recovering energy from hot wares includes a standalone cabinet structure having a housing that defines an internal rack receiving space and an energy recovery system associated with the cabinet structure. The rack receiving space is sized to receive and hold multiple racks of hot wares at the same time. The energy recovery system is configured to transfer heat from the hot wares to a fluid passing through the cabinet structure. A method of recovering heat from wares, and a warewash machine that includes an energy recovery system are also described.

### TECHNICAL FIELD

This application relates generally to ware handling systems and warewashers such as those used in commercial applications such as cafeterias and restaurants and, more particularly, to energy recovery from hot wares.

### BACKGROUND

Commercial warewashers commonly include a housing area which defines washing and rinsing zones for dishes, pots, pans and other wares. Heat losses from warewash machines are mainly through the vents, drains, machine surfaces, wares exiting the machine and both ends of the machine in the case of conveyance types machines. Insulation and curtain structures have been used to limit energy losses from machines. Heat recovery systems have also been used to recover heat from the machine that would ordinarily be lost to the machine exhaust or drains. However, hot wares exiting the machine can still constitute up to about 40% of the total energy loss.

It would be desirable to provide a heat recovery system that provides the ability to recover heat from hot wares exiting the machine.

### SUMMARY

In one aspect, a device for recovering energy from hot wares is provided, including a standalone cabinet structure having a housing that defines an internal rack receiving space and an energy recovery system associated with the cabinet structure. The rack receiving space is sized to receive and hold multiple racks of hot wares at the same time. The energy recovery system is configured to transfer heat from the hot wares to a fluid passing through the cabinet structure.

In another aspect, a method of recovering heat from hot wares is provided. The method includes cleaning a collection of wares in a warewash machine having a wash zone, heat being added to the collection of wares during cleaning, resulting in clean hot wares. The clean hot wares are removed from the warewash machine and placed into a standalone cabinet structure. Fluid is circulated through at least a portion of the cabinet structure while heat from the clean hot wares is transferred to the fluid.

In another aspect, a warewash machine is provided. The warewash machine includes a chamber for receiving wares and an energy recovery system associated with the chamber. The chamber includes at least one wash zone, and the energy recovery system is configured to transfer heat from the wares to a fluid.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic front elevation of one embodiment of a cabinet type device to recover energy from wars; and

FIG. 2 is a schematic front elevation of another embodiment of a cabinet type device;

FIG. 3 is a schematic side elevation of a warewash machine with a ware energy recovery system.

### DETAILED DESCRIPTION

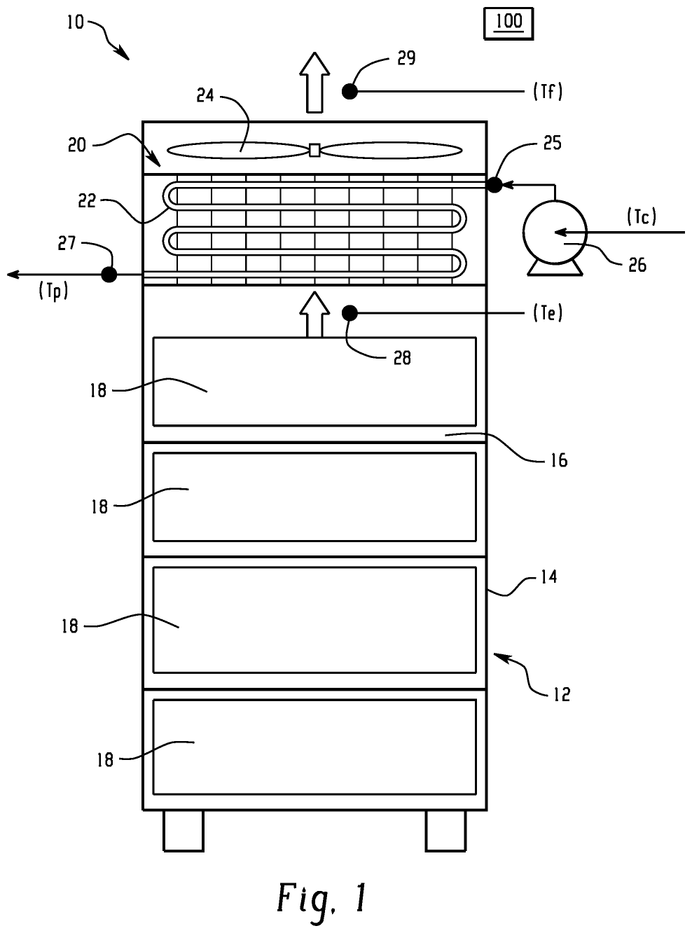

Referring to FIG. 1, a device 10 for recovering energy from hot wares takes the form of a standalone cabinet structure 12 having a housing 14 that defines an internal rack receiving space 16. The rack receiving space is sized to receive and hold multiple racks 18 of hot wares at the same time (e.g., where the racks have been removed from a warewash machine after washing). A door or doors, or alternatively a drawer or drawers, on the cabinet structure may provide access to the space 16 for moving racks in and out. An energy recovery system 20 is associated with the cabinet structure, where the energy recovery system is configured to transfer heat from the hot wares to a fluid passing through the cabinet structure. The fluid may be water or a refrigerant medium. Here, the energy recovery system 20 includes a heat exchanger 22 (e.g., a coil) through which the fluid travels and a blower unit 24 for moving air past the wares and across the heat exchanger 22. A pump 26 may control the fluid flow through the coil. The operating speed of the blower and/or a damper position on the blower unit may control the air flow.

A temperature probe 28, such as a thermometer or a thermocouple, may be placed near the top of the rack receiving space 16 to measure the temperature before the heat exchanger (Te), and a similar temperature probe 29 may be placed near the blower unit 24 in the flow of air exiting the blower unit 24 to measure the exhaust temperature (Tf). Similarly, a temperature probe 25, 27 may be placed near the entrance and exit location, respectively, of the fluid passing through the heat exchanger 22 to measure the temperature of the cold incoming fluid (Tc) and the temperature of the preheated fluid (Tp) leaving the heat exchanger 22.

The fluid flow through the heat exchanger 22 and/or air flow across the heat exchanger 22 is varied to provide a predetermined heat exchanger temperature condition. For example, a defined air temperature drop across the heat exchanger (Te−Tf) may be set and the fluid flow rate through the heat exchanger 22 varied to maintain the defined air temperature drop. Alternatively, a defined fluid temperature gain through the heat exchanger (Tp−Tc) may be set and the blower unit air flow controlled to maintain the defined fluid temperature gain. Alternatively, a defined air exhaust temperature (Tf) may be set and the fluid flow through the heat exchanger and/or blower unit air flow may be controlled to maintain the defined exhaust air temperature. In particular, the air temperature drop across the heat exchanger 22 and/or the fluid temperature gain through the heat exchanger 22 can be controlled to maintain the defined air exhaust temperature (Tf).

Where the fluid is water, the outgoing fluid may be delivered to a hot water booster of a nearby warewash machine. Where the fluid is a refrigerant medium, the outgoing refrigerant medium may be delivered to a compressor associated with a heat pump system of a warewash machine.

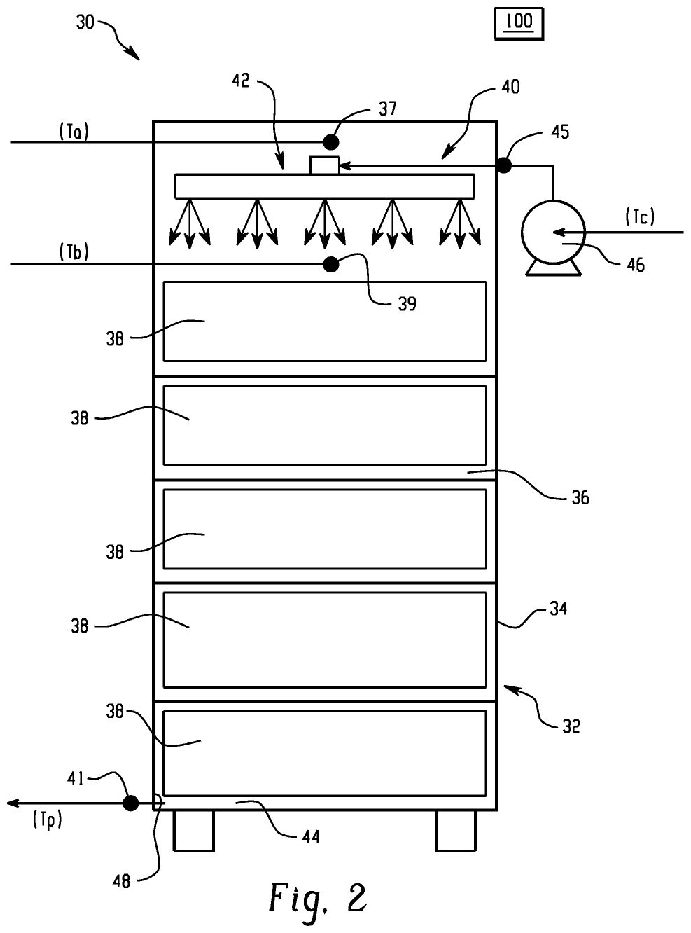

Referring now to FIG. 2, another embodiment of a device 30 is shown including a standalone cabinet structure 32 having a housing 34 that defines an internal rack receiving space 36. The rack receiving space is sized to receive and hold multiple racks 38 of hot wares at the same time (e.g., where the racks have been removed from a warewash machine after washing). A door or doors, or alternatively a drawer or drawers, on the cabinet structure may provide access to the space 36 for moving racks in and out. An energy recovery system 40 is associated with the cabinet structure, where the energy recovery system is configured to transfer heat from the hot wares to a fluid passing through the cabinet structure. Here, the fluid may be water and the energy recovery system includes a spray system 42 (e.g., spray arm or arms with associated spray nozzles) for spraying the water on the wares, and a collection system 44 for collecting the sprayed fluid after it passes downward over the wares. The flow of water may be controlled by a pump 46.

A temperature probe 37, such as a thermometer or a thermocouple, may be placed above the spray system 42 to measure the temperature after (Ta) the spray system 42, and a similar temperature probe 39 may be placed below the spray system 42 to measure the temperature before (Tb) the spray system 42. Similarly, a temperature probe 45 may be placed near the entrance location of the fluid into the machine 30 to measure the temperature of the cold incoming fluid (Tc).

The spray of fluid is controlled to achieve a desired temperature condition of the energy recovery system. For example, a defined temperature drop before (below) and after (above) the spray system 42 (Tb−Ta) may be set and the flow of the incoming water to the spray system varied to maintain the defined temperature drop. Alternatively, a defined temperature after (above) the spray system (Ta) may be set and the flow of the incoming water to the spray system varied to maintain the defined temperature.

A water outlet 48 of the cabinet may be connected to deliver the water to a water input of a nearby warewash machine (e.g., for feeding a booster or a machine tank). A temperature probe 41, such as a thermometer or a thermocouple, may be placed near the water outlet 48 to measure temperature of the fluid leaving (Tp) the device 30.

In another aspect, a method of recovering heat from hot wares begins with cleaning a collection of wares in a warewash machine. Heat is added to the collection of wares during cleaning, resulting in clean hot wares. The clean hot wares are then removed from the warewash machine and placed into a standalone cabinet structure. Fluid is then circulated through at least a portion of the cabinet structure, allowing heat from the clean hot wares to be transferred to the fluid.

The fluid may be water or a refrigerant. If water is used, the water could be circulated through a coil situated in an upper half of the standalone cabinet. The water output from the coil could then be circulated back to an input of the warewash machine to be used for cleaning and/or rinsing another set of wares.

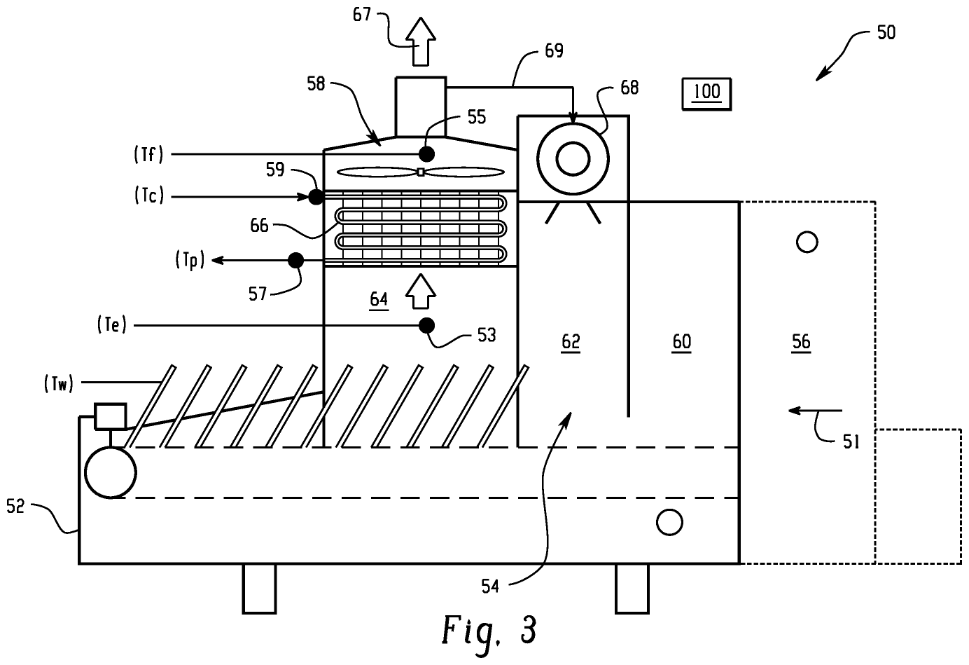

Referring now to FIG. 3, a warewash machine 50 for washing wares includes a housing 52 defining an internal chamber 54 through which wares are conveyed along the direction of the conveyor 51 for cleaning, where the chamber has multiple spray zones, including at least one wash zone 56 which includes a recirculation system with associated collection tank (not shown). An energy recovery system 58 is associated with the chamber, where the energy recovery system is configured to transfer heat from hot wares to a fluid thereby lowering the ware exiting temperature (Tw).

Here, the warewasher includes a final-rinse zone 60 downstream of the wash zone 56 and a drying zone 62 downstream of the final rinse zone. The energy recovery system pulls air from a recovery zone 64 downstream of the drying zone 62 and moves the air across a heat exchanger 66 (e.g., a coil) through which the fluid travels. As shown, at least some of the pulled air may be exhausted from the warewash machine as exhaust air 67 and at least some of the pulled air may be delivered to an intake 69 of a blower unit 68 of the drying zone, in either case after the pulled air has been moved across the heat exchanger 66.

A temperature probe 55, such as a thermometer or a thermocouple, may be placed above the energy recovery system 58 to measure the exhaust temperature (Tf), and a similar temperature probe 57 may be placed below the energy recovery system 53 to measure the temperature before the heat exchanger (Te). Similarly, a temperature probe 59, 57 may be placed near the entrance and exit location, respectively, of the fluid passing through the energy recovery system 58 to measure the temperature of the incoming cold fluid (Tc) and the temperature of the outgoing preheated fluid (Tp).

In operation, a defined air temperature drop across the heat exchanger 66 (Te−Tf) may be set and the fluid flow rate through the heat exchanger 66 varied to maintain the defined air temperature drop. Alternatively, a defined fluid temperature gain through the heat exchanger 66 (Tp−Tc) may be set and the blower unit 68 air flow controlled to maintain the defined fluid temperature gain. Alternatively, a defined air exhaust temperature (Tf) may be set and the fluid flow through the heat exchanger and/or the blower unit air flow controlled to maintain the defined exhaust air temperature. Alternatively, a defined fluid exit temperature (Tp) may be set and the fluid flow through the heat exchanger and/or the blower unit air flow controlled to maintain the defined fluid exit temperature.

If the fluid is water, the water out of the heat exchanger may be delivered to a booster heater and/or a collection tank in one of the machine zones after passing through the heat exchanger. If the fluid is a refrigerant medium, the refrigerant medium may be delivered to a compressor of a heat pump system of the machine 50 after passing through the heat exchanger.

Systems in which the various energy recovery systems describe above are combined (e.g., in series or in parallel) are also possible.

The described systems recover more energy from wares than prior warewash systems, also resulting in cooler wares that are easy to handle.

In each of the above embodiments, temperature sensors can be provided at the various locations indicated as needed for the control techniques described above, along with a controller 100 configured to carry out the techniques. Blower speed sensors, air flow sensors (e.g., anemometer) and/or damper position sensors could also be provided. As used herein, the term controller is intended to encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other control components, or a combination of some or all of the above, that carries out the control functions of the system.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application.

1. A device for recovering energy from hot wares, comprising:
a standalone cabinet structure having a housing that defines an internal rack receiving space, wherein the rack receiving space is sized to receive and hold multiple racks of hot wares at the same time;
an energy recovery system associated with the cabinet structure, the energy recovery system configured to transfer heat from the hot wares to a fluid passing through the cabinet structure.

2. The device of claim 1 wherein the fluid is one of water or a refrigerant medium.

3. The device of claim 1 wherein the energy recovery system includes a heat exchanger through which the fluid travels and a blower unit for moving air past the wares and across the heat exchanger.

4. The device of claim 3 wherein at least one of a fluid flow through the heat exchanger and/or air flow across the heat exchanger is varied to provide a predetermined heat exchanger temperature condition.

5. The device of claim 3 wherein:
a defined air temperature drop across the heat exchanger is set and the fluid flow rate through the heat exchanger is varied to maintain the defined air temperature drop.

6. The device of claim 3 wherein:
a defined fluid temperature gain through the heat exchanger is set and the blower unit air flow is controlled to maintain the defined fluid temperature gain.

7. The device of claim 3 wherein:
a defined air exhaust temperature is set and the fluid flow through the heat exchanger and or blower unit air flow is controlled to maintain the defined exhaust air temperature.

8. The device of claim 1 wherein the fluid is water and the energy recovery system includes a spray system for spraying the fluid on the wares, and a collection system for collecting the sprayed fluid after it passes over the wares.

9. The device of claim 8 wherein:
a defined temperature drop before and after the spray system is set and flow of the incoming water to the spray system is varied to maintain the defined temperature drop.

10. The device of claim 8 wherein:
a defined temperature after the spray system is set and flow of the incoming water to the spray system is varied to maintain the defined temperature.

11. The device of claim 1 wherein the fluid is water, the cabinet structure includes a water outlet and the water outlet is connected to deliver the water to a water input of a nearby warewash machine.

12. The device of claim 1 wherein the fluid is a refrigerant medium, the cabinet structure includes a refrigerant output that is connected to deliver the refrigerant medium to a refrigerant medium input of a nearby warewash machine.

13. A method of recovering heat from hot wares, comprising:
cleaning a collection of wares in a warewash machine having a wash zone, wherein heat is added to the collection of wares during cleaning, resulting in clean hot wares;
removing the clean hot wares from the warewash machine;
placing the clean hot wares into a standalone cabinet structure; and
circulating a fluid through at least a portion of the cabinet structure;
wherein heat from the clean hot wares is transferred to the fluid.

14. The method of claim 13 wherein the fluid is water that is circulated through a coil situated in an upper half of the standalone cabinet, and the water is output from the cabinet structure and delivered via a connection line to an input of the warewash machine.

15. A warewash machine for washing wares, comprising:
a chamber for receiving the wares, the chamber having at least one wash zone; an energy recovery system associated with the chamber, the energy recovery system configured to transfer heat from the wares to a fluid.

16. The warewash machine of claim 15 wherein
the warewash machine includes a final-rinse zone downstream of the wash zone and a drying zone downstream of the final rinse zone; and
the energy recovery system pulls air from a recovery zone downstream of the drying zone and moves the air across a heat exchanger through which the fluid travels.

17. The warewash machine of claim 16 wherein at least some of the pulled air is exhausted from the warewash machine and at least some of the pulled air is delivered to an intake of a blower of the drying zone, in either case after the pulled air has been moved across the heat exchanger.

18. The warewash machine of claim 16 wherein:
a defined air temperature drop across the heat exchanger is set and the fluid flow rate through the heat exchanger is varied to maintain the defined air temperature drop.

19). The warewash machine of claim 16 wherein:
a defined fluid temperature gain through the heat exchanger is set and the blower unit air flow is controlled to maintain the defined fluid temperature gain.

20. The warewash machine of claim 16 wherein:
a defined air exhaust temperature is set and the fluid flow through the heat exchanger and/or the blower unit air flow is controlled to maintain the defined exhaust air temperature;
or
a defined fluid exit temperature is set and the fluid flow through the heat exchanger and/or the blower unit air flow is controlled to maintain the defined fluid exit temperature.

21-23. (canceled)
